(19) United States
(12) Patent Application Publication
(10) Pub. No.: US 2004/0178945 A1
(43) Pub. Date: Sep. 16, 2004

(54) Object location system for a road vehicle

(76) Inventor: Alastair James Buchanan, West Midlands (GB)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/744,243

(22) Filed: Dec. 22, 2003

Related U.S. Application Data
(63) Continuation of application No. PCT/GB02/02916, filed on Jun. 24, 2002.

(30) Foreign Application Priority Data
Jun. 23, 2001 (GB) 0115433.5

(51) Int. Cl. G01S 13/93; G01S 13/86

(52) U.S. Cl. 342/70; 342/54; 342/55

(57) ABSTRACT

An object location system for identifying the location of objects positioned in front of a host road vehicle (100), comprising: a first sensing means (101) such as a radar or lidar system which transmits a signal and receives reflected portions of the transmitted signal, obstacle detection means (103) adapted to identify the location of obstacles from information from the first sensing means (101); image acquisition means (102) such as a video camera adapted to capture a digital image of at least part of the road ahead of the host vehicle (100); image processing means (103) which processes a search portion of the captured digital image, the search portion including the location of obstacles indicated by the obstacle detection means (103) and being smaller than the captured digital image; and obstacle processing means which determine characteristics of detected obstacles. A method or using such a system is also disclosed.

The invention relates to an object location system capable of detecting objects, such as other vehicles, located in front of a host road vehicle. It also relates to vehicle tracking systems and to a method of locating objects in the path of a host vehicle.

Vehicle tracking systems are known which are mounted on a host road vehicle and use radar or lidar or video to scan the area In front of the host vehicle for obstacles. It is of primary importance to determine the exact position of any obstacles ahead of the vehicle In order to enable the system to determine whether or not a collision is likely. This requires the system to determine accurately the lateral position of the obstacle relative to the direction of travel of the host vehicle and also the range of the obstacle.

The driver assistance system can then use the information about the position of the obstacle to issue a warning to the driver of the host vehicle or to operate the brakes of the vehicle to prevent a collision. It may form a part of au intelligent cruise control system which allows the host vehicle to track an obstacle such as a preceding vehicle.

Typically, the radar sensor would lob an object such as a target vehicle by looking for a reflected signal returned from a point or surface on the target vehicle. The position of this point of reflection is locked into the system and tracked. An assumption is made that the, point of reflection corresponds to the centre of the rear of the advanced vehicle. However, it has been found that the position of the reflection on the target vehicle does not necessarily correlate with the geometric centre of the rear surface of the vehicle as usually the reflection would be generated from a “bright spot” such as a vertical edge or surface associated with the rear or side elevation of the target vehicle. Nevertheless. radar type systems are extremely good at isolating a target vehicle and provide extremely robust data with regard to the relative distance and therefore speed of the target vehicle.

Video systems on the other hand are extremely poor at determining the range of a target object when all that the system can provide is a two dimensional graphical array of data. However, attempts have been made to process video images in order to detect targets in the image and distinguish the targets from noise such as background features.

To reliably detect a target vehicle using a camera-based system, every artefact in a captured image must be analysed. In a typical image scene there could be any number of true and false targets, such as road bridges, trees, pedestrians and numerous vehicles. The processing power required to dimensionalize each of these targets is fundamentally too large for any reasonable automotive system and the data that is obtained is often useless in real terms as the range for each and every target cannot be determined with any accuracy. The problem is compounded by the need to analyse many images in sequence in real time.

It is an object of the present invention to provide an object location system for a road vehicle that is capable more accurately, of determining the true position and therefore path of a target vehicle.

In accordance with a first aspect the invention provides an object location system for identifying the location of objects positioned in front of a host road vehicle, the system comprising:

a first sensing means including a transmitter adapted to transmit a signal in front of the host vehicle and a detector adapted to detect a portion of the transmitted signal reflected from a target;

obstacle detection means adapted to identify the location of at least one obstacle or target using information obtained by the first sensing means;

image acquisition means adapted to capture a digital image of at least a part of the road in front of the host vehicle;

image processing means adapted to process a search portion of the digital image captured by the image acquisition means which includes the location of the target determined by the obstacle detection means, the area of the search portion being smaller than the area of the captured digital image, and

obstacle processing means adapted to determine one or more characteristics of the identified target within the search portion of the image from the information contained in the search portion of the image.

By in front of the vehicle it will of course be understood that we means an area located generally ahead of the front of the vehicle. The actual areas will depend on the field of view of the sensing means and the image acquisition means and will typically be a wide field of view, say 100 degrees, centred on a line extending directly in front of the host vehicle.

The first sensing means preferably comprises a radar or lidar target detection system which employs a time of flight echo location strategy to identify targets within a field of view. The transmitter may emit radar or lidar signals whilst the detector detects reflected signals. They may be integrated into a single unit which may be located as the front of the host vehicle. Of course, other range detection systems which may or may not be based on echo-detection may be employed.

The image acquisition means may comprise a digital video camera. This may capture digital images of objects within the field of view of the camera either continuously or periodically. The camera may comprise a CCD array. By digital image we mean a two-dimensional pixellated image of an area contained within the field of view of the camera.

An advantage of using a radar system (or lidar or similar) to detect the probable location of objects a very accurate measurement of the range of the object can be made. The additional use of video image data corresponding to the area of the detected object allows the characteristics of the object to be more accurately determined than would be possible with radar alone.

The image processing means may include a digital signal processing circuit and an area of electronic memory in which captured images may be stored during analysis. It may be adapted to identify the edges of any artefacts located within an area of the captured image surrounding the location indicated by the radar system. Edge detection routines that can be employed to perform such a function are well known in the art and will not be described here.

The image processing means may be adapted to process the information contained within a search portion of the captured image corresponding to a region of the captured image surrounding the location of a probable obstacle. The area of the searched portion may correspond to 10 percent or less, or perhaps 5 percent or less of the whole captured image. The reduced search area considerably reduces the processing overheads that are required when compared with a system analysing the whole captured image. This is advantageous because it increases the processing speed and reduces costs. The analysed area may be centred on the point at which the sensing means has received a reflection.

As the point of reflection of a radar signal is not necessarily the centre point of an object the area analysed is preferably selected to be larger than the expected size of the object. This ensures that the whole of an object will be contained in the processed area even of the reflection has come from a corner of the object.

In a further refinement, the area of the search portion of the image, or its width or height, may be varied as a function of the range of the identified image. A larger area may be processed for an object at a close range, and a smaller area may be processed for an object at a greater distance from the host vehicle. The area or width or height may be increased linearly or quadratically as a function of decreasing distance to the target object.

The characteristics determined by the object processing means may comprise one or more of:

The type of object-car, lorry, pedestrian,

The width of the object;

The heading of the object;

The lateral position of the object relative to the host vehicle, i.e. its displacement from a projected path of the host vehicle;

The centre point of the object, or of the rear face of the object.

Of course, it will be appreciated that other characteristics not listed above may be determined in addition to or as an alternative to the listed characteristics.

The width of the object may be determined by combining the width of the object in the captured image with the range information determined by the radar (or lidar or similar) detection system. The image processor may therefore count the number of pixel widths of the detected object.

The image processing means may detect all the horizontal lines and all the vertical lines in the searched area of the captured image. The characteristics of the object may be determined wholly or partially from these lines, and especially from the spacing between the lines and the cross over points for vertical and horizontal lines. It may ignore lines that are less than a predetermined length such as lines less than a predetermined number of pixels in length.

After the location of edges in the search portion of the image, the boundaries of the searched portion may be altered to exclude areas that do not include the detected object. The processing may then be repeated for the information contained in the reduced-area search image portion. This can in some circumstances help to increase the accuracy of the analysis of the image information.

The image processing means may also employ one or more rules when determining the characteristics of the object. One such rule may be to assume that the object possesses symmetry. For example, it may assume that the object is symmetrical about a centre point.

The obstacle detection means may be adapted to produce a target image scene corresponding to an image of the portion of the road ahead of the host vehicle in which one or more markers are located, each marker being centred on the location of a source of reflection of the transmitted signal and corresponding to an object identified by the first sensing means. For instance, each marker may comprise a cross hair or circle with the centre being located at the centre point of sources of reflection. The marker may be placed in the target image frame using range information obtained from the time of flight of the detected reflected signal and the angle of incidence of the signal upon the detector.

The image processor may be adapted to overlay the target image scene with the digital image captured by the image acquisition means, i.e. a frame captured by a CCD camera. For convenience, the sensing means and the image acquisition means may have the same field of view which make the overlay process much simpler.

With the target image scene overlaid on top of the video scene, and once the radar has identified the target obstacles, the video image can be examined in a small area or window around the overlaid target scene. This allows for appropriate video image processing in a discrete portion of the whole video image scene, thus reducing the processing overhead.

Once the characteristics of the target object have been identified, this data can then be combined with the accurate range information provided by the first sensing means to physically pin point and measure the target width and therefore deduce the geometric centre of the target. The target can then be tracked and its route can be determined more robustly, particularly when data from the video image scene is used to determine lane and road boundary information.

The image processing means may be further adapted to identify any lane markings on the road ahead of the host vehicle from the captured image. The detected image may filter be transformed from a plan view into a perspective view assuming that the road is flat. Alternatively, if the road is not flat, the image processing means may determine a horizon error by applying a constraint of parallelism to the lane markings. This produces a corrected perspective image in which the original image has been transformed.

Where a transformation has been applied to the capture image to correct for undulations in the road, a corresponding correction may be applied to the output of the first setting means, i.e. the output of the radar or lidar system.

A suitable correction scheme that can be applied is taught in the applicants earlier International Patent Application number W099/44173. This permits the target images and the captured video images to be transformed into a real-world plane.

The image processing means may be adapted to determine the lane in which an identified target is travelling and its heading from the analysed area of the captured image or of the transformed image.

The system may capture a sequence of images over time and track and identified object from one image to the next. Over time, the system may determine the distance of the object from the host from the radar signal and its location relative to a lane from the video signal.

Where the return signal is lost from a detected object, the system may employ the video information alone obtained during the lost time to continue to track an object.

A maximum time period may be determined after which the reliability of tracking based only on the captured image data may be deemed to be unreliable.

Since it is reasonable to assume that the width of a tracked vehicle will not change from image to image over time, the width determined from previous images may be used to improve the reliability of characteristics determined from subsequent images of the object. For instance, the characteristic of a tracked vehicle may be processed using a recursive filter to improve reliability of the processing.

In accordance with a second aspect the invention provides a method of determining one or more characteristics of an object located ahead of a host vehicle, the method comprising:

transmitting a signal front of the host vehicle and detecting a portion of the transmitted signal reflected from a target,

identifying the location of at least one obstacle ahead of the host vehicle from the reflected signal,

capturing a digital image of at least a part of the road ahead of the host vehicle,

processing a search area of the captured digital image which includes the location of the obstacle identified from the reflected signal, the area processed being smaller than the area of the captured digital image,

and determining one or more characteristics of the identified obstacle from the information contained in the processed image area.

The determined characteristics may include the physical width of the object and the type of object identified.

The reflected signal may be used to determine the range of the object, i.e. its distance from the host vehicle. The method may combine this range information with the width of any identified artefacts in the processed image portion to determine the actual width of the object.

The method may further comprise processing a larger area of the captured image for objects that are close to the host vehicle than for objects that are farther away from the host vehicle.

The method may comprise processing the image portion to identify objects using an edge detection scheme.

The method may comprise identifying a plurality of objects located in front of the host vehicle.

The method may comprise detecting the location of lanes on a road ahead of the vehicle and placing the detected object in a lane based upon the lateral location of the vehicle as determined from the processed image.

In accordance with a third aspect the invention provides a vehicle tracking system which incorporates an object location system according to the first aspect of the invention and/or locates objects according to the method of the second aspect of the invention.

There will now be described, by way of example only, one embodiment of the present invention with reference to the accompanying drawings of which:

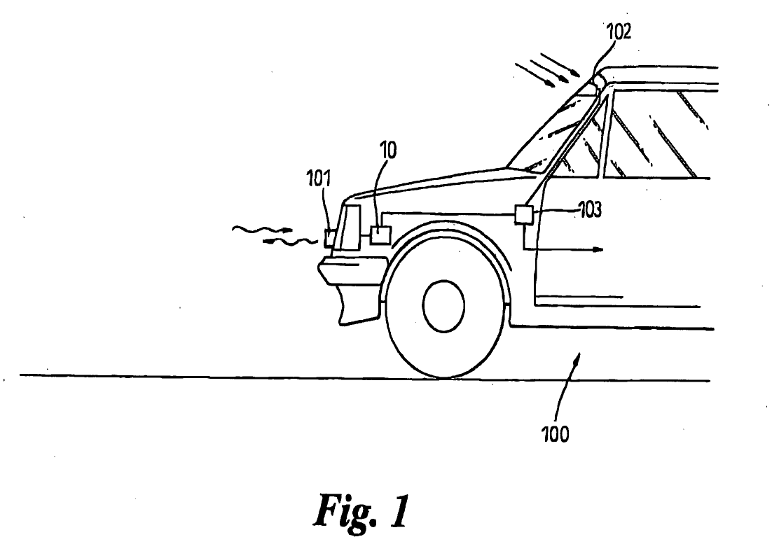

FIG. 1 is an overview of the component parts of a target tracking system according to the present invention;

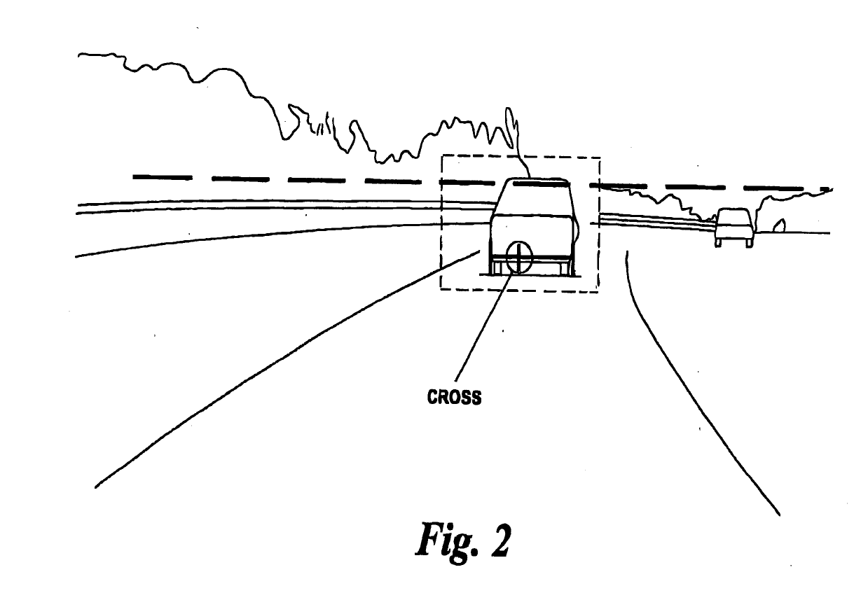

FIG. 2 is an illustration of the system tracking a single target vehicle traveling in front of the host vehicle;

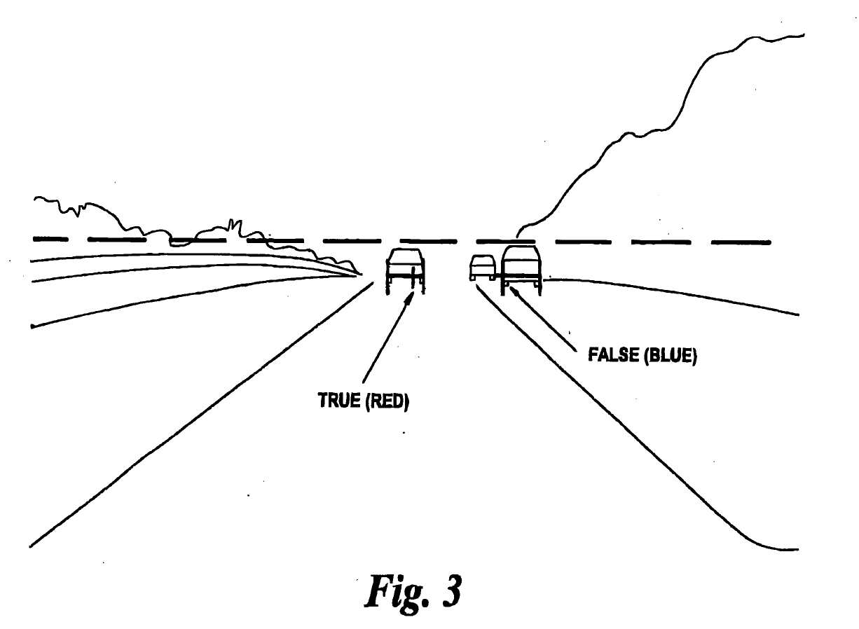

FIG. 3 is an illustration of the system tracking two target vehicles traveling in adjacent lanes in front of the host vehicle; and

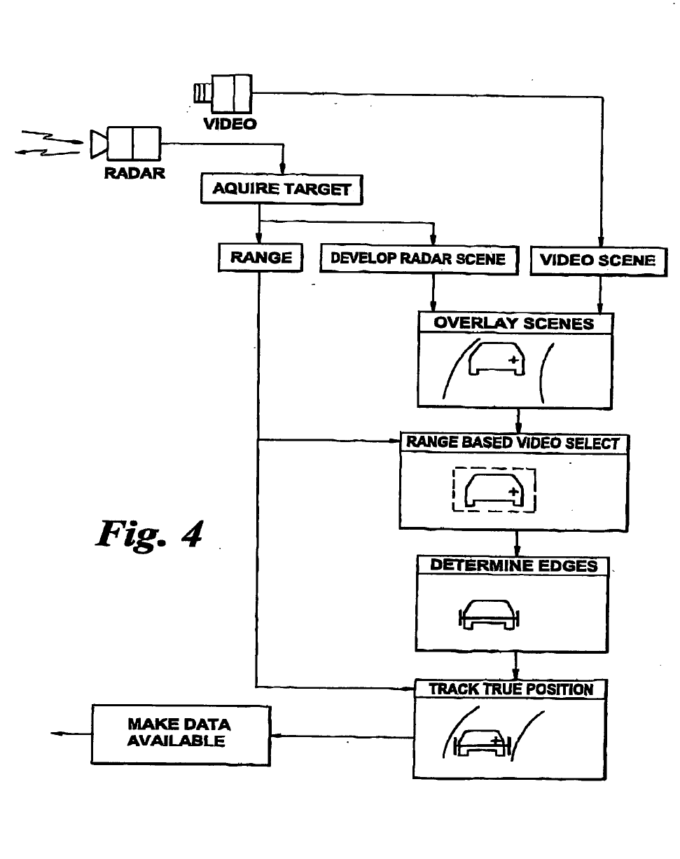

FIG. 4 is a flow diagram setting out the steps performed by the tracking system when determining characteristics of the tracked vehicle.

The apparatus required to implement the present invention is illustrated in FIG. 1 of the accompanying drawings. A host vehicle 100 supports a forward-looking radar sensor 101 which is provided substantially on the front of the vehicle in the region of 0.5 m from the road surface. The radar sensor 101 emits and then receives reflected signals rented from a surface of a target vehicle traveling in advance of the host vehicle. Additionally, a forward-looking video image sensor 102 is provided in a suitable position, which provides a video image of the complete road scene in advance of the system vehicle.

Signals from the radar sensor 101 are processed in a controller 103 to provide target and target range information. This information is combined in controller 103 with the video image scene to provide enhanced target dimensional and range data. This data is further used to determine the vehicle dynamic control and as such, control signals are provided to other vehicle systems to affect such dynamic control, systems such as the engine management, brake actuation and steering control systems. This exchange of data may take place between distributed controllers communicating over a CAN data bus or alternatively, the system may be embodied within a dedicated controller.

FIG. 2 illustrates the system operating and tracking a single target vehicle. The radar system has identified a target vehicle by pin pointing a radar reflection from a point on said vehicle, as illustrated by the cross hair “+”. As can be seen, the radar target return signal is from a point that does not correspond with the geometric centre of the vehicle and as such, with this signal alone it would be impossible to determine whether the target vehicle was traveling in the centre of it's lane or whether it was moving to change to the more left hand lane. In real time, the radar reflection moves or hovers around points on the target vehicle as the target vehicle moves. It is therefore impossible with radar alone to determine the true trajectory of the target vehicle with any real level of confidence.

Once a target has been selected, the video image is examined in a prescribed region of the radar target signal. The size of the video image area window varies in accordance with the known target range. At a closer range a larger area is processed than for a greater range.

Within the selected area, all vertical and horizontal edges are extrapolated in the target area and from the crossing of these lines a true vehicle width can be determined. In order to maintain the robustness of the target data, the aforementioned determinations are performed repeatedly in real time. As long as the radar target return signal is present, data concerning the true target position is derived from the video image scene. As can be seen in this illustration, the video image data places the target vehicle in the centre position of the traffic lane, whereas the data from the radar signal alone would lead us to believe that the vehicle is moving towards the left hand lane. The combined use of radar and video to first target and determine range of target, together with video to determine physical position, provides an enhanced target data set, which ensures more robust control of the vehicle.

In FIG. 3, an image of two tracked targets is provided where the first radar cross (thick lines) represents the true target vehicle. A second (thinner lines) radar cross is also shown on a vehicle travelling in an adjacent lane. The system measures the range of each vehicle and suitably sized video image areas are examined for horizontal and vertical edges associated with the targets. True vehicle widths, and therefore vehicle positions are then determined. As can be seen, the vehicle travelling in the right hand lane would, from its radar signal alone, appear to be moving into the system vehicle's late and therefore represents a threat.

In this scenario, the vehicle brake system may well be used to reduce the speed of the system vehicle to prevent a possible collision. Examination of the video image data reveals that the vehicle in question is actually traveling within its traffic lane and does not represent a threat. Therefore, the brake system would not be deployed and the driver would not be disturbed by the vehicle slowing down because of this false threat situation.

The present invention also provides enhanced robustness in maintaining the target selection. As the target moves along the road, as mentioned earlier, the target radar radar return signal hovers around as the target vehicle bodywork moves. Occasionally, the radar return signal can be lost and therefore the tracking system will lose its target. It may then switch to the target in the adjacent lane believing it to be the original target.

In the present system, at least for transitory losses in the radar target return signal, the video image scene can be used to hold on to the target for a short period until a radar target can be re-established. Obviously, as time progresses the range information from the video data cannot be relied upon with any significant level of confidence and therefore if the radar target signal cannot be reinstated, the system drops the target selection.

The aforementioned examples all operate by fusing data from the radar and video image systems. The system can, in amore advance configuration, be combined with a lane tracking system to produce a more robust analysis of obstacles. This can be summarised as follows:

Step 1. A road curvature or lane detection system, such as that described in our earlier patent application number GB0111979.1 cans be used to track the lanes in the captured video image scene and produce a transformed image scene that is corrected for variations in pitch in the scene through its horizon compensation mechanism.

With the aforesaid horizon compensation method, a video scene position offset can be calculated from the true horizon and, as the positional relationship between the video and radar system sensors is known, the video scene can be translated so that it directly relates to the area covered by the detect radar scene.

Step 2. Given the correct transformation, provided by the lane detection system, the obstacles detected by the radar can be overlaid on the video image. The radar image may also be transformed to correct for variations in the pitch of the road.

Step 3. A processing area can be determined on the video image, based on information regarding the obstacle distance obtained by radar, an the location of the obstacle relative to the centre of the radar, and the size of a vehicle can be determined.

Step 4. This region can then be examined to extract the lateral extent of the object. This can be achieved by several different techniques

Edge point—the horizontal and vertical edges can be enacted.

The extent of the horizontal lines can then be examined, the ends being determined when the horizontal lines intersect vertical lines,

Symmetry—the rear vehicles generally exhibit symmetry. The extent of this symmetry can be used to determine the vehicle width

A combination of symmetry and edges

Step 5. The extracted vehicle width can be tracked from frame to frame, using a suitable filter, increasing the measurement reliability and stability and allowing the search region to be reduced which in turn reduces the computational burden.

The aforementioned processing steps are illustrated in FIG. 4 of the accompanying drawings. The vehicle mounted radar sensor sends and receives signals, which are reflected from a target vehicle. Basic signal processing is performed within the sensor electronics to provide a target selection signal having range information. From the target selection signal a radar scene is a vertical elevation is developed, Additionally, a video image scene is provided by the vehicle-mounted video camera. These two scenes are overlaid to produce a combined video and radar composition.

Based upon the radar target position within the video image scene, an area, the size of which is dependent upon the radar range, is selected. The with, and therefore true position of the target is then computed by determining and extrapolating all horizontal and vertical edges to produce a geometric shape having the target width information. Knowing the target width and the road lane boundaries, the target can be placed accurately within the scene in all three dimensions i.e. range—horizontal position—vertical position.

Once the target edges have been computed, the size of the image area under examination can be reduced or concentrated down to remove possible errors in the computation introduced by transitory background features moving through the scene.

With the true target position with respect to the road boundaries and the true range given by the radar, an accurate and enhanced signal can be provided that allows systems of the intelligent cruise or collision mitigation type to operate more reliably and with a higher level of confidence.

What is claimed is:

1. An object location system for identifying the location of objects positioned in front of a host road vehicle, the system comprising:
a first sensing means including a transmitter adapted to transmit a signal in front of the host vehicle and a detector adapted to detect a portion of the transmitted signal reflected from a target;
an obstacle detection means adapted to identify the location of at least one obstacle or target using information obtained by the first sensing means;
an image acquisition means adapted to capture a digital image of at least a part of the road in front of the host vehicle;
an image processing means adapted to process a search portion of the digital image captured by the image acquisition means which includes the location of the target determined by the obstacle detection means, the area of the search portion being smaller than the area of the captures digital image; and
an obstacle processing means adapted to determine one or more characteristics of the identified target within the search portion of the image from the information contained in the search portion of the image.

2. An object location system according to claim 1 in which the first sensing means comprises a radar or lidar target detection system which employs a time of flight echo location strategy to identify targets within a field of view.

3. An object location system according to claim 1 in which the image acquisition means comprises a digital video camera.

4. An object location system according to claim 1 in which the image processing means includes a digital signal processing circuit and an area of electronic memory in which captured images are stored during analysis.

5. An object location system according to claim 4 in which the image processing means is adapted to identify the edges of any artifacts located within an area of the captured image surrounding the location indicated by the radar system.

6. An object location system according to claim 1 in which the image processing means is adapted to process the information contained within a search portion of the captured image corresponding to a region of the captured image surrounding the location of a probable obstacle.

7. An object location system according to claim 6 in which the search portion is centred on a point from which the sensing means has received a reflection.

8. An object location system according to claim 6 in which the search portion is larger than the expected size of the target.

9. An object location system according to claim 1 in which at least one of the area of the search portion of the image, the width of the search portion of the image, and the height of the search portion of the image is varied as a function of the range of the identified target.

10. An object location system according to claim 1 in which the characteristics determined by the object processing means comprise one or more of:
The type of object-car, lorry, pedestrian,
The width of the object;
The heading of the object;
The lateral position of the object relative to the host vehicle, i.e. its displacement from a projected path of the host vehicle;
The centre point of the object, or of the rear face of the object.

11. An object location system according to claim 10 in which the width of the object is determined by combining the width of the object in the captured image with the range information determined by the first sensing means.

12. An object location system according to claim 1 in which the image processing means employs one or more rules when determining the characteristics of the object.

13. An object location system according to claim 12 in which one such rule is to assume that the object possesses symmetry.

14. An object location system according to claim 1 in which a target image scene is produced corresponding to an image of the portion of the road ahead of the host vehicle in which one or more markers are located, each marker being centred on the location of a source of reflection of the transmitted signal and corresponding to an object identified by the first sensing means.

15. An object location system according to claim 1 in which the image processing means is further adapted to identify any lane markings on the road ahead of the host vehicle from the captured image.

16. A method of determining one or more characteristics of an object located ahead of a host vehicle, the method comprising:
transmitting a signal in front of the host vehicle and detecting a portion of the transmitted signal reflected from a target;
identifying the location of at least one obstacle ahead of the host vehicle from the reflected signal;
capturing a digital image of at least a part of the road ahead of the host vehicle;
processing a search area of the captured digital image which includes the location of the obstacle identified from the reflected signal, the area processed being smaller than the area of the captured digital image; and
determining one or more characteristics of the identified obstacle from the information contained in the processed image area.

17. The method of claim 16 in which the determined characteristics include the physical width of the object and the type of object identified.

18. The method of claim 16 in which the reflected signal is used to determine the range of the object from the host vehicle and further comprising the step of combining this range information with the width of any identified artifacts in the processed image portion to determine the actual width of the object.

19. The method of claim 16 which further comprises processing a larger area of the captured image for objects that are close to the host vehicle than for objects that are farther away from the host vehicle.

20. The method of claim 16 in which the image portion is processed to identify objects using an edge detection scheme.

21. The method of claim 16 which comprise identifying a plurality of objects located in front of the host vehicle.

22. The method of claim 16 which further comprises detecting the location of lanes on a road ahead of the vehicle and placing the detected object in a lane based upon the lateral location of the vehicle as determined from the processed image.

23. A vehicle tracking system which incorporates an object location system according to claim 1.

24. A vehicle tracking system which locates objects according to the method of claim 16.
